(19) United States
(12) Patent Application Publication
(10) Pub. No.: US 2002/0153145 A1
(43) Pub. Date: Oct. 24, 2002

(54) Double blade edger spacing adapter

(76) Inventor: Thomas John Holzinger, Norwalk, CA (US)

Correspondence Address: Dr. Timothy F. Grubb, Esq., Attorney at Law, 18792 Haven Lane, Yorba Linda, CA, 92668-2630, US

(21) Appl. No.: 09/841,555

(22) Filed: Apr. 24, 2001

(51) Int. Cl. A01D 15/00

(52) U.S. Cl. 172/15

(57) ABSTRACT

A blade spacing adapter for holding a plurality of blades for use with lawn edging machines wherein the adapter specifically holds the blades in a position whereby a first blade is fixed in a relative position perpendicular to a second blade. The thickness of the edger blade spacing adapter which demountably engages edger blades determines the width of the “cut”. Grooves on both sides of the bracket are perpendicular one to the other and are of sufficient width to hold industry-standard size lawn edger blades. When the blades are appropriately fixed on the bracket and are rotated by the engine, they define two circular planes which appear parallel to one another. The bracket contains an appropriate sized mounting hole by which the bracket and multiple edger blades may be affixed to the edger.

### CROSS-REFERENCE TO RELATED APPLICATIONS

Not Applicable.

### STATEMENT REGARDING FEDERALLY SPONSORED RESEARCH OR DEVELOPMENT

Not Applicable.

### REFERENCE TO A MICROFICHE APPENDIX

Not Applicable.

### FIELD OF THE INVENTION

The present invention relates to an edger blade spacing adapter for securing multiple standard-sized lawn edger cutting blades. By utilizing an adapter of varying thickness, the width of the cut to be produced can be varied proportionately in order to achieve a furrow of the desired dimension.

### BACKGROUND OF THE INVENTION

Lawn edging devices have long been used to cut a relatively narrow furrow defined by the lines created between hardscape such as sidewalks, driveways, buildings, stones, etc., and softscape such as a lawn or other landscaping features, the purpose of which is to create a clean, finished and pleasing appearance for the property.

Traditionally, lawn edging devices utilize a single flat cutting blade consisting of oppositely directed arms radiating outward from a central aperture through which extends a connecting arm or axle to hold a blade in place. Power to rotate the blade which can be generated by electricity, gas or other means, is transmitted to the blade via the axle to which the blade is affixed. Numerous such devices are described in the prior art, a few of such U.S. patents are cited below for reference:

U.S. Pat. No. 3,683,606—Staines

U.S. Pat. No. 5,036,654—Malutich

U.S. Pat. No. 4,229,933—Bernard

U.S. Pat. No. 3,563,015—Renfroe

U.S. Pat. No. 4,471,603—Veltin

U.S. Pat. No. 3,684,027—Crawford

U.S. Pat. No. 3,684,028—Crawford

U.S. Pat. No. 3,103,093—House

There are however, occasions when from both a consideration of utility and of visual interest, the creation of a wider furrow is desirable. In terms of utility, a wider space between hardscape (driveways, sidewalks, mow strips, etc.) and softscape (lawn, flowerbeds, etc.) translates into a less frequent necessity for edging the desired area; in terms of visual interest, a wider space is at times more appealing to the creator.

Traditionally two methods have been implemented in the creation of a wider cut. The first simply utilizes a thicker blade such that the distance created between lawn and sidewalk for example, merely reflects and is a function of the actual thickness of the blade affixed to the edging device, see U.S. Pat. No. 4,979,573 Williamson, which uses a blade up to ½ inch in width. A limiting factor of such an approach is that as the width of the blade is increased, a greater power or force must necessarily be employed in order to overcome the additional frictional resistance of the blade against the surfaces to be cut. At some point, the width of the blade and/or the cost of generating sufficient energy to spin the blade ultimately limits the size of the cut to be produced.

A second-approach has been to utilize a multiple blade configuration to produce the wider cut. Samples of this approach appear in U.S. patents:

U.S. Pat. No. 2,913,058—Smith et al

U.S. Pat. No. 3,141,507—Henry et al

U.S. Pat. No. 4,678,042—Barton et al

U.S. Pat. No. 4,653,590—Shank

U.S. Pat. No. 5,592,992—Thompson

While much of the prior art has sought to solve the problem of how to create a wider furrow, the thrust of the methods for meeting this goal has necessitated the utilization of either thicker than usual blades, or involved the use of multiple customized blades with unique features; the drawback being the necessity of locating and obtaining unique or custom blades rather than using readily available industry standard-type edger blades. A need continues to exist that will permit the user to create or sustain a wider cut than is currently possible while keeping costs and inconvenience to a minimum and still utilize readily available standard-sized edging blades. In the interest of eliminating the need to use custom blades with various and sometimes limiting power requirements, the present invention presents a unique method for holding multiple blades of standard size for easy use in the creation of a wider cut.

It is therefore, an object of the present invention to provide a new blade holding means for securing multiple edger blades. A specific advantage of the invention is that the bracket accommodates currently utilized and inexpensive industry standard size edger blades obviating the need to create, locate or suffer the added expense of obtaining or replacing custom blades.

Another object of the present invention is to provide the ability to produce a wide cut between for example, lawn and sidewalk, the width of which remains independent or minimally dependent upon the actual width of the edger blade utilized, and instead is dependent primarily upon the thickness of the holding bracket selected.

A further object is to provide a means for easily and effectively lengthening the longevity of the edger blades by creating a means whereby both sides of multiple blades can be used for cutting. By flipping a blade over and repositioning it on the bracket, maximal blade life can be realized by utilizing the cutting edges of all blades thereby increasing the longevity of the blade utility which traditionally decreases as a consequence of “wear and tear” on single blades during normal use.

An additional object of the present invention is to increase the effective mass of the blade/bracket configuration on an edger such that centrifugal force of the spinning blades' rotational efficiency is maximized at operational speeds. The spinning of this increased mass facilitates overcoming frictional resistance experienced by the cutting blades producing less wear on the engine generating the power to spin the blades.

A further object of the invention is to provide a bracket which securely, independently, and demountably, holds the blades in place such that in the event one of the blades should break or becomes dysfunctional, the edger can continue to be utilized with only a single blade, albeit the cut will be limited to the width of the original blade.

### BRIEF SUMMARY OF THE INVENTION

The present invention relates generally to lawn edging devices and more particularly to an edger blade bracket for holding and maintaining multiple blades at predetermined fixed angles one to the other. The thickness of the bracket determines the distance between the blades and thereby the width of the edging path to be cut.

### BRIEF DESCRIPTION OF THE DRAWINGS

FIG. 1 is a perspective view of the edger of the type to be used with the present invention.

FIG. 2 is an exploded view of the blade edger spacing adapter showing the relative positions of the adapter, multiple edger blades, drive shaft and vertical guard plate.

FIG. 3 is an simplified explosion view showing the present invention with blades demounted from adapter and displayed in their relative positions.

FIG. 4 is a semi planer view showing the spacing adapter and position of two edger blades as fitted abutting the adapter according to one preferred embodiment.

FIG. 5 is a side view taken through the line 4-4 of FIG. 4 showing edger blades and adapter configuration with blades in place.

FIG. 6 is an elevational view of the mounting bracket in accordance with a preferred embodiment of one aspect of the present invention.

FIG. 7 is a side view taken through line 5-5 of FIG. 6, wherein the bracket is illustrated perpendicular to the plane illustrated in FIG. 6.

### DESCRIPTION OF THE PREFERRED EMBODIMENT

The present invention relates generally to lawn edging attachments which provide the user with the ability to simultaneously utilize multiple edger blades in the creation and/or maintenance of various landscaping features. Interchangeable multiple edger blades of a standard shape and size are securely held in place by an edger blade spacing adapter in such a way that a wider furrow than that generally created by utilization of a single standard edger blade can be produced. As will be shown, the bracket provides ease of use, inexpensive design, and the ability to utilize all cutting edges of the attached blades to maximize blade life and utility. By flipping the blades and repositioning them within the bracket, and reversing the blades in relation one to another, cutting edges on multiple blades become leading edges in such a way that all cutting surfaces of the multiple blades are utilized. For the present invention, the width of the cut is predominately dependent upon the width of the mounting bracket and only minimally dependent upon the actual thickness of the edger blades. In this way, inexpensive, standard blades which are readily available at hardware stores, nurseries, and similar outlets can be utilized to produce “non-standard” width cuts dependent instead upon the thickness of the edger blade adapter selected. Because the bracket represented by the present invention accommodates commercially available standard-size blades, replacement blades will remain easy to find and cheaper to replace than the more expensive specialized or hard to find custom edger blades representative of the prior art.

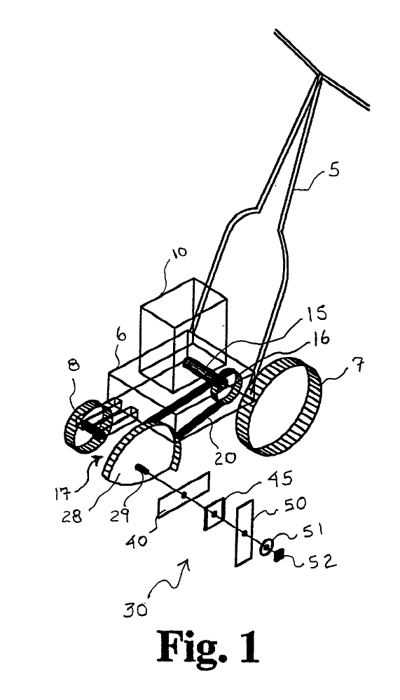

With reference to FIGS. 1-7, descriptions to the preferred embodiment of the invention and specific language relating thereto will now be made in order to promote a clear understanding of the invention and its utility.

In the perspective view drawing of FIG. 1., an edger of the type that is used with the present invention to cut a wide furrow between “hardscape” and “softscape” is shown. As shown in the drawing, handle 5 is attached to generally horizontal mounting plate 6 upon which electric or gasoline engine 10 and wheels 7 and 8 are mounted. Power from drive shaft 15 which is part of engine 10 is transmitted through pulley wheel 16 and belt 20 a second pulley wheel (obscured in drawing by vertical guard plate 29) to which a second horizontally situated drive shaft 29 is attached. Affixed on shaft 29 is multiple edger blade spacing adapter assembly 30. Shaft 29 extends through blade 40, edger blade spacing adapter 45, blade 50, washer 51 and is secured with nut 52.

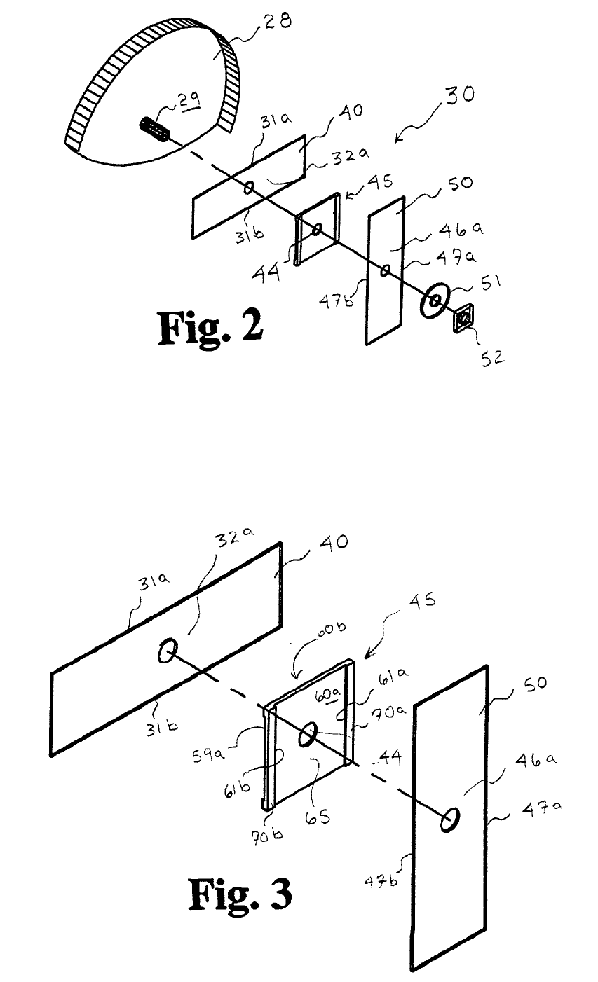

Referring to the drawings, FIGS. 2-3 show edger blade spacing adapter 45 of the present invention according to its simplest embodiment. Edger blade spacing adapter 45 has two opposed predominately flat planer surfaces 60(a) and 60(b). A central region 65 of adapter 45 has an aperture 44 through which shaft 29 can pass.

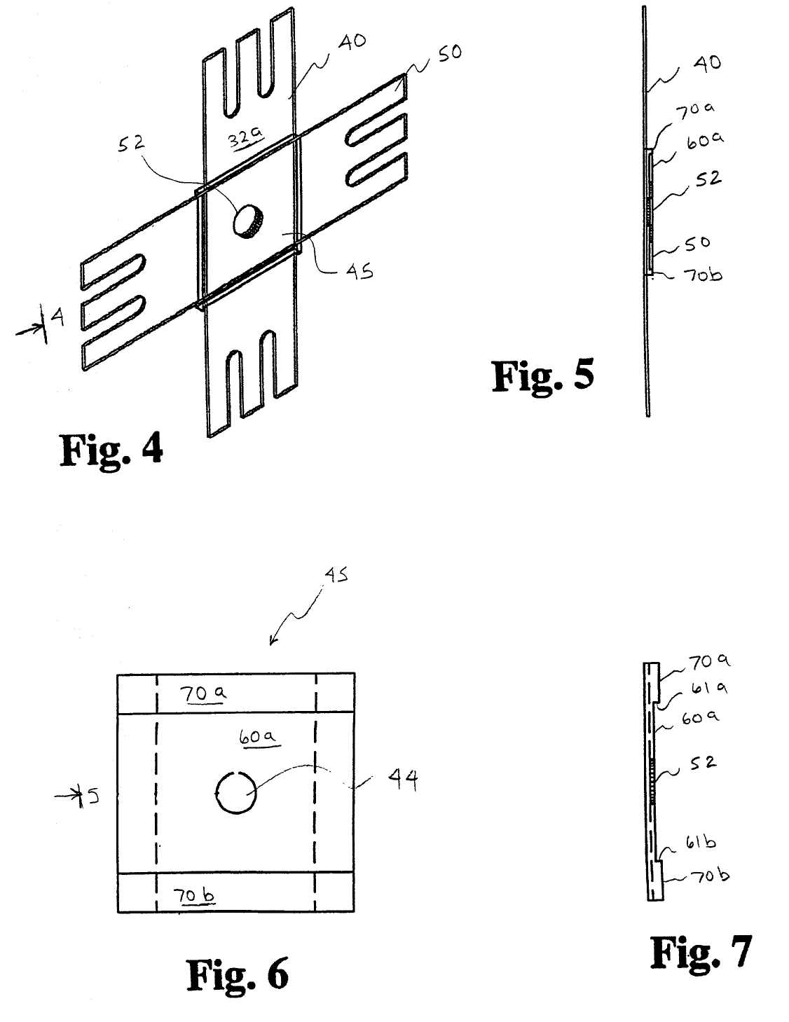

As shown in FIGS. 6-7, elevated strips 70(a) and 70(b) run parallel to, and extend the length of, the perimeter of two of the four outermost edges of bracket face 60(a) such that a wide, flat groove is formed therebetween. The face of strips 70(a) and 70(b) are substantially coplanar with one another and parallel to bracket face 60(a). Perpendicular to face of strips 70(a) and 70(b) and bracket face 60(a) and facing inwardly toward the central section of edger bracket 45 are longitudinal edges 61(a) and 61(b) formed at the union of the relative faces 70(a) and bracket face 60(a) and 70(b) and bracket face 60(a). The thickness of strips 70(a) and 70(b) as measured at edges 61(a) and 61(b) coincide with the thickness of a standard commercially available edger blades such that when edger blade 50 is in it's optimal position on the bracket 45, the outward face of edger blade 50 and face of strips 70(a) and 70(b) are coplanar. Outer edges of the central portion 46(a) of edger blade 50 are held in relative position by support provided by contact along the length of longitudinal edges 61(a) and 61(b). On the opposite side of edger blade bracket 45 are identical features as described above for bracket face 60(a), strips 70(a) and 70(b) and longitudinal edges 61(a) and 61(b) however, the relative position of these features is rotated 90 degrees such that the strips and wide, flat notch assume positions perpendicular to one another. Furthermore, when edger blades 40 and 50 are held in position on edger blade adapter 45, the blades also assume a position perpendicular to one another as demonstrated in FIG. 4. In the preferred embodiment, the perpendicular relationship of blades 40 and 50 improves the balance of the entire assembly. When blades 40 and 50 are appropriately positioned on edger blade bracket 45 and rotated by engine 10 about axis of shaft 29, two parallel planes are defined, the space therebetween determining the width of the furrow created.

It should be appreciated that by utilizing edger blade bracket adapter 45 of varying widths, the width of the furrow created can be altered to satisfy the needs or desires of the user. Edger blade bracket adapter of varying widths are easily interchangeable such that different width cuts may be made while continuing to utilize the same standard edger blades and lawn edging machine.

While it has been described and illustrated in detail and drawings one specific embodiment of the preferred invention, it should be understood that such is intended to be illustrative only and is not intended to be specifically restrictive of the scope of the invention. Changes or modifications may be made without departing from the spirit of the invention and are desired to be protected such that any applications of the principles of the invention as shown or as would be contemplated or normally occur to one skilled in the art to which it pertains shall fall within the scope, spirit, and desired protection of the invention.

What is claimed is:

1. An edger blade spacing adapter for a lawn edging machine, said adapter comprising:
(a) a predominately flat first planer surface having a central portion defining a hole and having a first raised strip extending along at least one edge of said flat first planer surface and a second raised strip extending along another edge of said flat first planer surface;
wherein said first and second raised strips are positioned oppositely in a spaced apart relationship such that a wide flat notch is defined therebetween; and
(b) a predominately flat second planer surface having a central portion defining a hole and having a first raised strip extending along at least one edge of said flat first planer surface and a second raised strip extending along another edge of said flat second planer surface; wherein said first and second raised strips are positioned oppositely in a spaced apart relationship such that a wide flat notch is defined therebetween.

2. The edger blade spacing adapter of claim 1 wherein said wide flat notch defined on said first flat planer surface and said wide flat notch defined on said second flat planer surface are perpendicular to one another.

3. The edger blade spacing adapter of claim 1 wherein said wide falt notch defined on said first flat planer surface and said wide flat notch defined on said second flat planer surface adapter are parallel to one another.

4. The edger blade spacing adapter of claim 1 wherein the width of said wide flat notch defined on said first flat planer surface and the width of said wide flat notch on said second flat planer surface coincide with the width of commercially available lawn edger blades.

5. The edger blade spacing adapter of claim 1 wherein said adapter is substantially square.

6. The edger blade spacing adapter of claim 1 wherein said adapter is substantially circular.

7. The edger blade spacing adapter of claim 1 wherein the thickness of said raised strips coincides with the thickness of a standard commercially available edger blade such that when edger blades are held on said adapter, the face of said edger blade and said raised strips are essentially coplanar.

8. A lawn edger, comprising:
(a) a handle to help guide the edger;
(b) a horizontal mounting plate on which to mount a motor;
(c) at least two wheels to facilitate moving the edger along the ground;
(d) a motor for providing power to rotate a shaft;
(e) a shaft operably attached to said motor;
(f) at least two edger blades; and
(g) an edger blade spacing adapter for holding said two edger blades; wherein said edger blade spacing adapter comprises:
(i) a predominately flat first planer surface having a central portion defining a hole and having a first raised strip extending along at least one edge of said flat first planer surface and a second raised strip extending along another edge of said flat first planer surface;
wherein said first and second raised strips are positioned oppositely in a spaced apart relationship such that a wide flat notch is defined therebetween; and
(ii) a predominately flat second planer surface having a central portion defining a hole and having a first raised strip extending along at least one edge of said flat first planer surface and a second raised strip extending along another edge of said flat second planer surface;
wherein said first and second raised strips are positioned oppositely in a spaced apart relationship such that a wide flat notch is defined therebetween.
